(19) United States
(12) Patent Application Publication
(10) Pub. No.: US 2026/0266993 A1
(43) Pub. Date: Sep. 10, 2026

(54) FMCW LIDAR SYSTEM AND FMCW FREQUENCY-SWEEPING METHOD

(71) Applicant: BEIJING MORELITE SEMICONDUCTOR CO., LTD., Beijing (CN)

(72) Inventors: Banghong ZHANG, Beijing (CN); Jie SUN, Beijing (CN); Tianbo SUN, Beijing (CN)

(21) Appl. No.: 18/993,494

(22) PCT Filed: Oct. 17, 2022
(86) PCT No.: PCT/CN2022/125557

§ 371 Date: Jan. 10, 2025

(30) Foreign Application Priority Data
Jul. 11, 2022 (CN) 202210809135.7

(51) Int. Cl. G01S 17/32; G01S 7/481; G01S 7/4911

(52) U.S. Cl. CPC G01S 17/32; G01S 7/4817; G01S 7/4911

(57) ABSTRACT

An FMCW LiDAR system and an FMCW frequency-sweeping method are provided. The FMCW frequency-sweeping method includes: acquiring a frequency-sweeping beam which performs within a preset ranging period n times of frequency-rising and n times of frequency-falling according to preset frequency-rising and frequency-falling slopes, n being a positive number, n≥2, a frequency-sweeping bandwidth of the frequency-sweeping beam and a preset total bandwidth meets the following relationship: f=fc/n, fc being the preset total bandwidth, f being the frequency-sweeping bandwidth (S401); splitting the frequency-sweeping beam into a signal beam and a local oscillation beam, wherein waveforms of the signal beam and the local oscillation beam being wholly identical (S403); transmitting the signal beam, the transmitted beam being reflected after encountering an obstacle to generate a reflected beam (S405); and measuring a beat frequency between the local oscillation beam and the reflected beam, to measure the distance of the obstacle (S407).

### CROSS-REFERENCE TO RELATED APPLICATION

This disclosure is a U.S. national application of PCT application No. PCT/CN2022/125557 filed on Oct. 17, 2022, which claims the priority of Chinese Patent Application No. 202210809135.7 filed on Jul. 11, 2022, the disclosure of which is hereby incorporated by reference in its entirety.

### TECHNICAL FIELD

The present disclosure relates to the technical field of LIght Detection And Ranging (LiDAR), and in particular, to an FMCW LiDAR system and an FMCW frequency-sweeping method.

### BACKGROUND

A LiDAR device is a radar system that detects characteristic quantities such as a position and a velocity of a target by emitting a laser beam. The working principle of the LiDAR device is to transmit a detection signal to the target, then compare a received signal reflected back from the target with the transmitted detection signal, and after appropriate processing, obtain related information of the target, such as parameters of a target distance, an orientation, a height, a speed, a posture, or even a shape of the target, so as to detect, track and identify the target such as an aircraft or a missile. The LiDAR device is now widely deployed in different scenarios, including automated vehicles. The LiDAR may actively estimate the distance and the speed of an environmental feature when scanning the scenario, and generate a point cloud position indicating a three-dimensional shape of the environmental scenario.

### SUMMARY

Some embodiments provide a Frequency-Modulated Continuous Wave (FMCW) frequency-sweeping method applied to a LIght Detection And Ranging (LiDAR) system, the method includes
obtaining a frequency-sweeping light beam;
splitting the frequency-sweeping light beam into an signal light beam and a local oscillation light beam, wherein frequency modulation waveforms of the signal light beam and the local oscillation light beam are completely same;
transmitting the signal light beam, wherein the transmitted light beam is reflected after encountering an obstacle to generate a reflected light beam; and
detecting a beat frequency between the local oscillation light beam and the reflected light beam to determine a distance of the obstacle,
wherein the frequency-sweeping light beam performs n times of frequency-rising based on a preset frequency-rising slope and performs n times of frequency-falling based on a preset frequency-falling slope in a preset frequency-sweeping ranging period, wherein n≥2, and a frequency-sweeping bandwidth of the frequency-sweeping light beam and a preset frequency-sweeping total bandwidth meet the following relationship:

$$f = {f}_{c} / n$$

wherein fc is the preset frequency-sweeping total bandwidth, and f is the frequency-sweeping bandwidth.

In some embodiments, the frequency-sweeping light beam sequentially and continuously performs └n┘ times of complete periodic frequency-rising and └n┘ times of complete periodic frequency-falling in the preset frequency-sweeping ranging period, └n┘ indicates that n is rounded down.

In some embodiments, the frequency-sweeping light beam continuously and alternately executes └n┘ times of complete periodic frequency-rising and └n┘ times of complete periodic frequency-falling in the preset frequency-sweeping ranging period, └n┘ indicates that n is rounded down.

In some embodiments, a distance R of the obstacle measured by the FMCW LiDAR system satisfies the following relationship:

$$R = \frac{{C}_{0}}{4} \frac{{t}_{c}}{{f}_{c}} ( \vert {f}_{b 1} \vert + \vert {f}_{b 2} \vert )$$

wherein tc is one half of the preset frequency-sweeping ranging period, fc is the preset frequency-sweeping total bandwidth, f_{b1} is a frequency-rising beat frequency in a frequency-rising stage, and f_{b2} is a frequency-falling beat frequency in a frequency-falling stage.

In some embodiments, a speed v of the obstacle measured by the FMCW LiDAR system satisfies the following relationship:

$$v = \frac{{C}_{0}}{4} \frac{1}{{f}_{o}} ( \vert {f}_{b 1} \vert + \vert {f}_{b 2} \vert )$$

wherein tc is one half of the preset frequency-sweeping ranging period, C₀ is the speed of light, f_{b1} is a frequency-rising beat frequency of a frequency-rising stage, f_{b2} is a frequency-falling beat frequency in a frequency-falling stage, and fo is a frequency of an unmodulated light beam.

In some embodiments, n satisfies the following relationship:

$$n < \frac{{t}_{c}}{{t}_{max}} and {t}_{max} = \frac{2 {R}_{max}}{{C}_{0}}$$

wherein tc is one half of the preset frequency-sweeping ranging period, Rmax is a preset maximum ranging distance, and C₀ is the speed of light.

Some embodiments of the present disclosure provide a Frequency-Modulated Continuous Wave (FMCW) LIght Detection And Ranging (LiDAR) system. The system includes:
a laser light source configured to generate a frequency-sweeping light beam;
an optical splitter configured to split the frequency-sweeping light beam into a signal light beam and a local oscillation light beam, wherein frequency modulation waveforms of the signal light beam and the local oscillation light beam are completely the same;
an optical transmitter configured to transmit the signal light beam, wherein the transmitted light beam is reflected to generate a reflected light beam after encountering an obstacle;
an optical receiver configured to receive the reflected light beam;
a detector configured to detect a beat frequency between the local oscillation light beam and the reflected light beam to determine a distance of the obstacle,
wherein the frequency-sweeping light beam performs n times of frequency-rising based on a preset frequency-rising slope and performs n times of frequency-falling based on a preset frequency-falling slope in a preset frequency-sweeping ranging period, wherein n≥2, and a frequency-sweeping bandwidth of the frequency-sweeping light beam and a preset frequency-sweeping total bandwidth meet the following relationship:

$$f = {f}_{c} / n$$

wherein fc is the preset frequency-sweeping total bandwidth, and f is the frequency-sweeping bandwidth.

Optionally, the frequency-sweeping light beam sequentially and continuously performs └n┘ times of complete periodic frequency-rising and └n┘ times of complete periodic frequency-falling in the preset frequency-sweeping ranging period, └n┘ indicates that n is rounded down.

Optionally, the frequency-sweeping light beam continuously and alternately executes └n┘ times of complete periodic frequency-rising and └n┘ times of complete periodic frequency-falling in the preset frequency-sweeping ranging period, └n┘ indicates that n is rounded down.

Optionally, the FMCW LiDAR system further comprises: a beam-scanning guide device, configured to adjust an emission direction of the transmitted light beam emitted from the optical transmitter over time to realize beam scanning.

Compared with the related art, the above solutions of the embodiments of the present disclosure have at least the following beneficial effects: the frequency-sweeping light beam generated by the Frequency-Modulated Continuous Wave (FMCW) LiDAR system performs n times of frequency-rising based on the preset frequency-rising slope in the preset frequency-sweeping ranging period and performs n times of frequency-falling based on the preset frequency-falling slope, the frequency-sweeping bandwidth of the frequency-sweeping light beam is obviously smaller than the preset frequency-sweeping total bandwidth, a large-range frequency-sweeping is replaced by a small-range frequency-sweeping in the FMCW ranging method of the present application, the same measurement effect is achieved, meanwhile, the frequency-sweeping bandwidth requirement is reduced, the FMCW LiDAR system is simple, the system power consumption is low, and the cost is reduced.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Obviously, the accompanying drawings in the following description are merely some embodiments of the present disclosure, and other drawings may be obtained by those skilled in the art according to these drawings without creative efforts. In the drawings:

FIG. 1 is a schematic structural diagram of an FMCW LiDAR system according to some embodiments of the present disclosure;

FIG. 2 is a waveform diagram of a transmitted light beam and a received light beam;

FIG. 3 is a waveform diagram of a beat frequency of a transmitted light beam and a received light beam; and

FIG. 4 is a flowchart of an FMCW frequency-sweeping method according to some implementations of the present disclosure.

### DETAILED DESCRIPTION

In order to make the objectives, technical solutions, and advantages of the present disclosure clearer, the present disclosure will be further described in detail below with reference to the accompanying drawings. All other embodiments obtained by a person of ordinary skill in the art based on the embodiments of the present disclosure without creative efforts shall fall within the protection scope of the present disclosure.

The terms used in the embodiments of the present disclosure are merely for the purpose of describing particular embodiments, and are not intended to limit the present disclosure. As used in the embodiments of the present disclosure and the appended claims, the singular forms “a”, “the” and “the” are also intended to include plural forms, unless the context clearly indicates other meanings, “a plurality of” generally includes at least two.

It should be understood that the term “and/or” used in this specification is merely an association relationship for describing associated objects, indicating that there may be three relationships, for example, A and/or B may indicate that A exists alone, A and B exist at the same time, and B exists alone. In addition, the character “/” in this specification generally indicates an “or” relationship between the associated objects.

It should be understood that although the terms “first”, “second”, “third”, etc. may be used in the embodiments of the present disclosure for description, the description should not be limited to these terms. These terms are only used to distinguish apart. For example, first may also be referred to as second, and similarly, second may also be referred to as first without departing from the scope of the embodiments of the present disclosure.

It should also be noted that the terms “comprising,” “including,” or any other variation thereof are intended to cover a non-exclusive inclusion, so that a commodity or apparatus including a series of elements not only includes those elements, but also includes other elements that are not explicitly listed, or further includes elements inherent to the commodity or apparatus. In the absence of more restrictions, an element defined by the sentence “including a” does not exclude that there are additional identical elements in the commodity or apparatus that includes the element.

In the related art, the existing LiDAR system mainly includes the following two technical routes: Time of Flight (ToF) and Frequency-Modulated Continuous Wave (FMCW).

The principle of ranging measurement of ToF is that the distance between the target object and the LiDAR system is measured by multiplying time of flight of a light pulse between the target object and the LiDAR by the speed of light, and the ToF LiDAR system adopts a pulse amplitude modulation technology. Different from the ToF route, the FMCW route mainly enables the received light beam to interfere with a local oscillation light beam by transmitting and receiving continuous laser beams, measure a frequency difference between the transmitted light beam and the received light beam by using a frequency-mixing detection technology, and then calculate the distance of the target object through the frequency difference. In short, ToF uses time to measure the distance, while FMCW uses frequency to measure the distance.

Compared with TOF, FMCW has the following advantages: an optical wave of ToF is easily interfered by ambient light, but anti-interference capability of FMCW is strong; a signal-to-noise ratio of ToF is too low, a signal-to-noise ratio of FMCW is very high; a quality of speed-dimension data of ToF is low, but FMCW can obtain speed-dimension data of each pixel.

The LiDAR system using the FMCW route has good technical advantages, but the following problems exist in practical applications. For FMCW LiDAR systems, a distance resolution is inversely proportional to a frequency modulation bandwidth. In order to improve the distance resolution, a large frequency modulation bandwidth is usually required, for example, a frequency modulation bandwidth above 3 GHz, for example, a distance resolution of 1 cm requires a frequency modulation bandwidth of 15 GHz. For a direct-modulation light source, such as a narrow linewidth DFB (Distributed Feedback Laser) laser device or an external cavity laser device, it is difficult to generate such wide linear frequency-sweeping in a short time; and for a laser system adopting external modulation, it is more difficult to generate a radio frequency signal with a large range of continuous frequency modulation, and at the same time, system bandwidth requirement is high, system complexity is high, and the cost is high.

The present disclosure provides an FMCW frequency-sweeping method applied to a LiDAR system, and the FMCW frequency-sweeping method includes: obtaining a frequency-sweeping light beam, wherein the frequency-sweeping light beam is split into a signal light beam and a local oscillation light beam, and frequency modulation waveforms of the signal light beam and the local oscillation light beam are completely the same; transmitting the signal light beam, so that the transmitted signal light beam is reflected after encountering an obstacle to generate a reflected light beam; detecting a beat frequency between the local oscillation light beam and the reflected light beam to determine a distance of a obstacle, wherein the frequency-sweeping light beam performs n times of frequency-rising based on a preset frequency-rising slope in a preset frequency-sweeping ranging period and performs n times of frequency-falling based on a preset frequency-falling slope, n is a positive number and n≥2, and a frequency-sweeping bandwidth of the frequency-sweeping light beam and a preset frequency-sweeping total bandwidth meet the following relationship: f=fc/n, where fc is the frequency-sweeping total bandwidth, and f is the frequency-sweeping bandwidth.

In the FMCW frequency-sweeping method provided by the present disclosure, n times of frequency-rising and n times of frequency-falling are performed on the basis of a preset slope within a preset frequency-sweeping ranging period, the frequency-sweeping bandwidth of the frequency-sweeping light beam is obviously smaller than the preset frequency-sweeping total bandwidth, a large frequency-sweeping range is replaced by multiple small frequency-sweeping ranges in a FMCW ranging mode of the present disclosure, the same ranging effect is achieved, and meanwhile, requirement of the frequency-sweeping bandwidth is reduced, so that the FMCW LiDAR system is simple, system power consumption thereof is low, and a cost thereof is reduced.

Optional embodiments of the present disclosure are described in detail below with reference to the accompanying drawings.

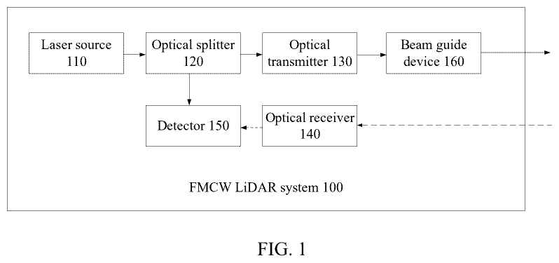

FIG. 1 is a schematic structural diagram of an FMCW LiDAR system according to some embodiments of the present disclosure. As shown in FIG. 1, the present disclosure provides an FMCW LiDAR system 100, including a laser light source 110, an optical splitter 120, an optical transmitter 130, an optical receiver 140, and a detector 150.

The FMCW LiDAR system 100 is configured to generate and receive one or more light beams. In some examples, at least some of components of the FMCW LiDAR system 100 may be integrated on a semiconductor chip to reduce the size of the FMCW LiDAR system 100. The components of the FMCW LiDAR system 100 may be implemented in the form of semiconductor modules on a chip.

The laser light source 110 may be integrated on a semiconductor chip, and may be directly modulated by a chirp signal, i.e., a driving signal for controlling the laser light source 110, which may be input to the laser light source 110 with a time varying intensity, so that the laser light source 110 generates and outputs the frequency-sweeping light beam, that is, a light beam whose frequency varies within a predetermined range. In some embodiments, the laser light source 202 may further include a modulator that receives a modulation signal. The modulator may be configured to modulate a generated light beam based on the modulation signal to generate and output the frequency-sweeping light beam, i.e. a beam of frequency that varies in a predetermined range. In some embodiments, the laser light source 110 may further include an external laser light source, and the external laser light source is introduced into the semiconductor chip through an optical path (for example, an optical fiber), a frequency of the generated light beam output by the laser light source 110 during un-modulation is substantially constant, and is referred to as a frequency of an unmodulated light beam, for example, 100-300 THz, the laser light source 110 may output the frequency-sweeping light beam after modulation, and a frequency range of the frequency-sweeping light beam is related to a frequency of the unmodulated light beam.

The optical splitter 120 is, for example, integrated on the semiconductor chip, configured to receive the frequency-sweeping light beam output from the laser light source 110, and further split the frequency-sweeping light beam into two parts, namely, the signal light beam and the local oscillation light beam. The signal light beam may be transmitted to the optical transmitter 130, the local oscillation light beam may be transmitted to the detector 150, wherein at any time instant, the signal light beam and the local oscillation light beam has the same frequency, i.e. the frequency modulation waveforms of the signal light beam and the local oscillation light beam are exactly the same.

The optical transmitter 130 is, for example, integrated on the semiconductor chip, and may be configured to transmit the signal light beam at a predetermined angle. When the transmitted light beam encounters an obstacle during propagation, a reflected light beam may be reflected on the surface of the obstacle. The reflected light beam may be received by an optical receiver 140. The optical receiver 140, for example, is integrated on the semiconductor chip, and may transmit the received reflected light beam to the detector 150

The detector 150 is, for example, integrated on the semiconductor chip, configured to detect a beat frequency between the local oscillation light beam and the reflected light beam to determine a speed and a distance of the obstacle, wherein the beat frequency refers to a frequency difference between the local oscillation light beam and the reflected light beam, and the detector 150 is, for example, a balanced detector.

In some embodiments, the FMCW LiDAR system 100 may further include a processor, which may also be integrated on the semiconductor chip, and the processor may calculate the distance of the obstacle according to the beat frequency detected by the detector 150, that is, the distance between the obstacle and the FMCW LiDAR system 100, and when the obstacle is a moving object, the processor may further calculate the speed of the obstacle according to the beat frequency detected by the detector 150.

In some embodiments, the FMCW LiDAR system 100 may further include a coupler, which is for example a mixer, arranged in front of the detector 150. The coupler is configured to couple (for example, mix) the local oscillation light beam and the reflected light beam. The coupler may also be integrated on the semiconductor chip, for example.

In some embodiments, the optical transmitter 130 and the optical receiver 140 may be integrated into one component, for example, a light transceiver, to realize coaxial transceiving, for example, the optical transmitter 130 and the optical receiver 140 may distinguish or separate a coaxial transmitted light beam and a coaxial reflected light beam by means of a device such as a polarizing beam splitting device or a three-port circulator, so that the reflected light beam may enter the detector 150 and perform beat frequency with the local oscillation light beam.

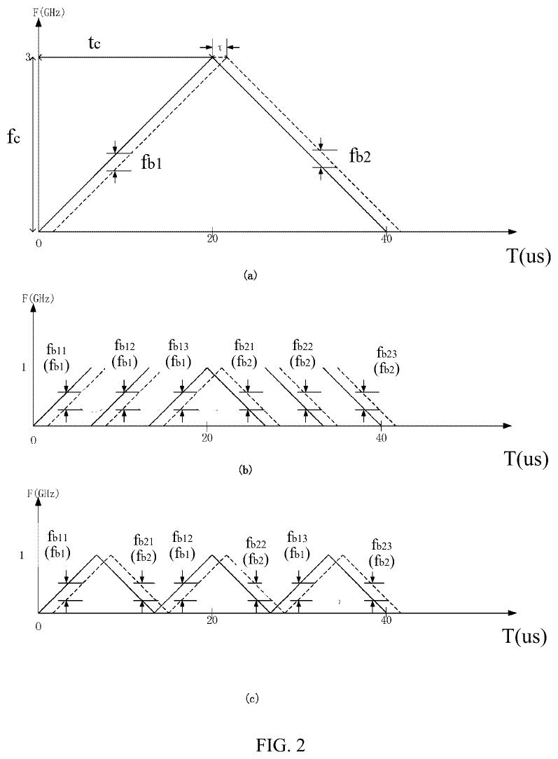

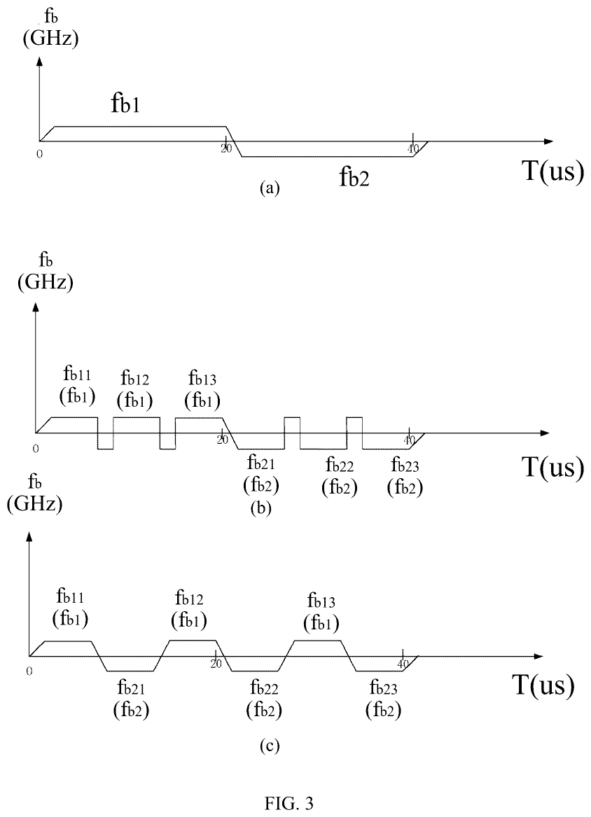

FIG. 2 is a waveform diagram of a transmitted light beam and a received light beam, wherein (a) is a waveform diagram of a transmitted light beam and a received light beam using a large frequency-sweeping bandwidth range in the related art, (b) is a waveform diagram of a transmitted light beam and a received light beam of a small frequency-sweeping bandwidth range provided in some embodiments of the present disclosure, and (c) is a waveform diagram of a transmitted light beam and a received light beam of a small frequency-sweeping bandwidth range provided in some embodiments of the present disclosure. FIG. 3 is a waveform diagram of a beat frequency of a transmitted light beam and a received light beam, wherein (a) is a waveform diagram of a beat frequency of a transmitted light beam and a received light beam using a large frequency-sweeping bandwidth range in the related art, (b) is a waveform diagram of a beat frequency of a transmitted light beam and a received light beam of a small frequency-sweeping bandwidth range provided in some embodiments of the present disclosure, and (c) is a waveform diagram of a beat frequency of a transmitted light beam and a received light beam of a small frequency-sweeping bandwidth range provided in some embodiments of the present disclosure. For ease of expression, (a), (b), and (c) in FIG. 2 are referred to as FIG. 2(a), FIG. 2(b), and FIG. 2(c), respectively, and (a), (b), and (c) in FIG. 3 are respectively referred to as FIG. 3(a), FIG. 3 (b), and FIG. 3(c).

As mentioned above, it is usually required that a laser frequency for an FMCW LiDAR system reaches a large frequency-sweeping bandwidth in tens of microseconds, for example, a frequency-sweeping bandwidth above 3 GHz, which has a very high requirement for hardware of the LiDAR system, resulting in complex system and expensive cost. FIG. 2 (a) shows a waveform diagram of a transmitted light beam and a received light beam of a large frequency-sweeping bandwidth range generated in this complex system.

As shown in FIG. 2(a), the abscissa represents time, the unit of time is s, the ordinate represents the frequency, and the unit of the frequency is GHz. The solid line represents a curve of the frequency of the transmitted light beam varying over time, the frequency of the transmitted light beam is increased from 0 to 3 GHz, for example, over time, and then reduced from 3 GHz to 0, and changes in this way periodically. Only one period is shown in FIG. 2 (a), that is, the preset frequency-sweeping ranging period, for example, 40 s. The dashed line represents a curve of the frequency of the reflected light beam varying over time, the transmitted light beam is reflected by the obstacle to form the reflected light beam, the reflected light beam is received by the optical receiver, and the reflected light beam maintains the frequency waveform of the transmitted light beam, and has a delay in time relative to the transmitted light beam. For example, the frequency of the reflected light beam, for example, increases from 0 to 3 GHz over time, and then drops from 3 GHz to 0, and changes in this way periodically. Only one period is shown in FIG. 2 (a), which is also a preset frequency-sweeping ranging period. In this case, in a preset frequency-sweeping ranging period, the transmitted light beam includes one frequency-rising stage and one frequency-falling stage, and correspondingly, the received reflected light beam also includes one frequency-rising stage and one frequency-falling stage in each period.

The frequency-sweeping bandwidth shown in FIG. 2 (a) is 3 GHz, which is referred to as a preset frequency-sweeping total bandwidth. In the above-mentioned complex FMCW LiDAR system in the related art, for example, the preset frequency-sweeping total bandwidth may be 3 GHz or more, and a frequency-sweeping interval does not necessarily start from 0, as long as it is ensured that the frequency-sweeping bandwidth of the frequency-sweeping interval is a large frequency-sweeping bandwidth range.

FIG. 3 (a) corresponds to FIG. 2 (a), the abscissa in FIG. 3 (a) represents time, the unit of time is μs, and the ordinate indicates that the unit of a beat frequency is GHz. In a preset frequency-sweeping ranging period, a beat frequency f_{b1} in the frequency-rising stage is positive, and a beat frequency f_{b2} in the frequency-falling stage is negative.

With reference to FIG. 2(a) and FIG. 3(a), the distance R of the obstacle measured by using the complex FMCW LiDAR system satisfies the following relationship:

$$R = \frac{{C}_{0}}{4} \frac{{t}_{c}}{{f}_{c}} ( \vert {f}_{b 1} \vert + \vert {f}_{b 2} \vert )$$

where t_{c} is one half of the preset frequency-sweeping ranging period, fc is the preset frequency-sweeping total bandwidth, f_{b1} is the beat frequency in the frequency-rising stage, and f_{b2} is the beat frequency in the frequency-falling stage.

Correspondingly, the speed v of the obstacle measured by using the complex FMCW LiDAR system satisfies the following relationship:

$$v = - \frac{{C}_{0}}{4} \frac{1}{{f}_{s}} ( \vert {f}_{b 1} \vert - \vert {f}_{b 2} \vert )$$

where t_{c} is one half of the preset frequency-sweeping ranging period, c₀ is the speed of light, f_{b1} is the beat frequency in the frequency-rising stage, f_{b2} is the beat frequency in the frequency-falling stage, and fs is the frequency of the unmodulated light beam.

Some embodiments of the present disclosure provide an FMCW LiDAR system with a simple structure and a low cost, which uses a frequency-sweeping light beam with a small frequency-sweeping bandwidth range to obtain substantially the same measurement effect as the frequency-sweeping light beam of the large frequency-sweeping bandwidth range shown in FIG. 2(a). A frequency-sweeping signal of a small frequency-sweeping bandwidth range is easy to implement, for example, a Direct Digital Frequency Synthesis (DDS) can generate a frequency-sweeping signal from 0 to 1 GHz, so that the FMCW LiDAR system has a simple structure and a reduced costs.

Specifically, in some embodiments of the present disclosure, the frequency-sweeping light beam performs n times of frequency-rising based on a preset frequency-rising slope and n times of frequency-falling based on a preset frequency-falling slope in a preset frequency-sweeping ranging period, n is a positive number, n≥2, and the frequency-sweeping bandwidth of the frequency-sweeping light beam and the preset frequency-sweeping total bandwidth meet the following relationship:

$$f = {f}_{c} / n$$

where f_{c} is the preset frequency-sweeping total bandwidth, and f is the frequency-sweeping bandwidth.

That is, a preset frequency-sweeping ranging period using a large frequency-sweeping bandwidth range including one frequency-rising stage and one frequency-falling stage is divided into a plurality of frequency-rising stages and a plurality of frequency-falling stages which adopt a small frequency-sweeping bandwidth range. The slope of the frequency-rising stage using the small frequency-sweeping bandwidth range is the same as the slope of the frequency-rising stage using the large frequency-sweeping bandwidth range, and the slope of the frequency-falling stage using the small frequency-sweeping bandwidth range is the same as the slope of the frequency-falling stage using the large frequency-sweeping bandwidth range. In this way, a frequency-sweeping light beam using a small frequency-sweeping bandwidth range may be used to achieve substantially the same measurement effect as a frequency-sweeping light beam using a large frequency-sweeping bandwidth range.

Specifically, as shown in FIG. 2 (b), the abscissa represents time, the unit of time is s; the ordinate represents the frequency, and the unit of frequency is GHz. The solid line represents a curve of the frequency of the transmitted light beam varying over time, and the frequency-rising stage in the preset frequency-sweeping ranging period of the transmitted light beam adopting the large frequency-sweeping bandwidth range shown in FIG. 2 (a) is divided into a plurality of frequency-rising stages with a small frequency-sweeping bandwidth range of the transmitted light beam, for example, the frequency-rising stage with the bandwidth of 3 GHz is split into three frequency-rising stages, each of which has a bandwidth of 1 GHz, and meanwhile, the frequency-falling stage in the preset frequency-sweeping ranging period of the transmitted light beam adopting the large frequency-sweeping bandwidth range shown in FIG. 2 (a) is divided into a plurality of frequency-falling stages of a small frequency-sweeping bandwidth range of the transmitted light beam. For example, a frequency-falling stage with a bandwidth of 3 GHz is divided into three frequency-falling stages, each of which has a bandwidth of 1 GHz.

As shown in FIG. 2 (b), the frequency-sweeping light beam sequentially and continuously performs three times of frequency-rising and three times of frequency-falling in a predetermined frequency-sweeping ranging period. In addition, the slope of the frequency-rising stage in FIG. 2 (b) is the same as the slope of the frequency-rising stage in FIG. 2 (a), and the slope of the frequency-falling stage in FIG. 2 (b) is the same as the slope of the frequency-falling stage in FIG. 2 (a). The slope of the frequency-rising stage in FIG. 2 (a) may be used as the preset frequency-rising slope, and the slope of the frequency-falling stage in FIG. 2 (a) may be used as the preset frequency-falling slope, and the two slopes may be the same or different.

FIG. 3 (b) corresponds to FIG. 2 (b), as shown in FIG. 3 (b), the abscissa represents time, the unit of time is μs, and the ordinate indicates that the beat frequency, the unit of frequency is GHz. In a preset frequency-sweeping ranging period, a first sub-frequency-rising beat frequency f_{b11} of a first frequency-rising stage, a second sub-frequency-rising beat frequency f_{b12} of a second frequency-rising stage, and a third sub-frequency-rising beat frequency f_{b13} of a third frequency-rising stage are all positive values, which are collectively referred to as the frequency-rising beat frequency f_{b1} in this embodiment. As shown in FIG. 3 (b) and FIG. 3 (a), the sum of the effective lengths of the frequency-rising beat frequency f_{b1} of FIG. 3 (b) (that is, the sum of the effective lengths of the first sub-frequency-rising beat frequency f_{b11}, the second sub-frequency-rising beat frequency f_{b12}, and the third sub-frequency-rising beat frequency f_{b13}) is less than the effective length of the frequency-rising beat frequency f_{b1} in FIG. 3 (a). The effective length of the beat frequency in the present disclosure refers to a time duration when the beat frequency signal has a stable value. A first sub-frequency-falling beat frequency f_{b21} of a first frequency-falling stage, a second sub-frequency-falling beat frequency f_{b22} of a second frequency-falling stage, and a third sub-frequency-falling beat frequency f_{b23} of a third frequency-falling stage are both negative values, which are collectively referred to as the frequency-falling beat frequency f_{b2} in this embodiment. As shown in FIG. 3 (b) and FIG. 3 (a), the sum of the effective lengths of the frequency-falling beat frequency f_{b2} of FIG. 3 (b) (i.e. the sum of the effective lengths of the first sub-frequency-falling beat frequency f_{b21}, the second sub-frequency-falling beat frequency f_{b22}, and the third sub-frequency-falling beat frequency f_{b23}) is less than the effective length of the frequency-falling beat frequency f_{b2} in FIG. 3 (a).

With reference to FIG. 2 (b) and FIG. 3 (b), the distance R of the obstacle measured by the FMCW LiDAR system in this embodiment satisfies the following relationship:

$$R = \frac{{C}_{0}}{4} \frac{{t}_{c}}{{f}_{c}} ( \vert {f}_{b 1} \vert + \vert {f}_{b 2} \vert )$$

where tc is one half of the preset frequency-sweeping ranging period, fc is the preset frequency-sweeping total bandwidth, f_{b1} is the frequency-rising beat frequency in the frequency-rising stage, and f_{b2} is the frequency-falling beat frequency in the frequency-falling stage.

Correspondingly, the speed v of the obstacle measured by the FMCW LiDAR system in this embodiment satisfies the following relationship:

$$v = - \frac{{C}_{0}}{4} \frac{1}{{f}_{s}} ( \vert {f}_{b 1} \vert - \vert {f}_{b 2} \vert )$$

where tc is one half of the preset frequency-sweeping ranging period, c₀ is the speed of light, f_{b1} is the frequency-rising beat frequency of the frequency-rising stage, f_{b2} is the frequency-falling beat frequency in the frequency-falling stage, and fs is the frequency of the unmodulated light beam.

That is, the distance measurement formula and the speed measurement formula of the FMCW LiDAR system using the small frequency-sweeping bandwidth range is the same as the distance measurement formula and the speed measurement formula of the FMCW LiDAR system using the large frequency-sweeping bandwidth range, so that a similar measurement effect can be obtained.

In some embodiments, as shown in FIG. 2 (c), the abscissa represents time, the unit of time is s; the ordinate represents the frequency, and the unit of frequency is GHz. The solid line represents a curve of the frequency of the transmitted light beam varying over time, and the frequency-rising stage in the preset frequency-sweeping ranging period of the transmitted light beam adopting the large frequency-sweeping bandwidth range shown in FIG. 2 (a) is divided into a plurality of frequency-rising stages of the transmitted light beam with a small frequency-sweeping bandwidth range, for example, the frequency-rising stage with the bandwidth of 3 GHz is divided into three frequency-rising stages, each of which has a bandwidth of 1 GHz, and meanwhile, the frequency-falling stage in the preset frequency-sweeping ranging period of the transmitted light beam adopting the large frequency-sweeping bandwidth range shown in FIG. 2 (a) is divided into a plurality of frequency-falling stages of a small frequency-sweeping bandwidth range. For example, a frequency-falling stage with a bandwidth of 3 GHz is divided into three frequency-falling stages, each of which has a bandwidth of 1 GHz.

As shown in FIG. 2 (c), the frequency-sweeping light beam sequentially and continuously performs frequency-rising and frequency-falling of three cycles in sequence in a predetermined frequency-sweeping ranging period. In addition, the slope of the frequency-rising stage in FIG. 2 (c) is the same as the slope of the frequency-rising stage in FIG. 2 (a), and the slope of the frequency-falling stage in FIG. 2 (c) is the same as the slope of the frequency-falling stage in FIG. 2 (a).

FIG. 3 (c) corresponds to FIG. 2 (c), as shown in FIG. 3 (c), the abscissa represents time, the unit of time is s, and the ordinate indicates the beat frequency, the unit of the beat frequency is GHz. In a preset frequency-sweeping ranging period, the first sub-frequency-rising beat frequency f_{b11} of the first frequency-rising stage, the second sub-frequency-rising beat frequency f_{b12} of the second frequency-rising stage, and the third sub-frequency-rising beat frequency f_{b13} of the third frequency-rising stage are all positive values, which are collectively referred to as the frequency-rising beat frequency f_{b1} in this embodiment. The effective length of the frequency-rising beat frequency f_{b1} of FIG. 3 (c) is less than the effective length of the frequency-rising beat frequency f_{b1} of FIG. 3 (a). The first sub-frequency-falling beat frequency f_{b21} of the first frequency-falling stage, the second sub-frequency-falling beat frequency f_{b22} of the second frequency-falling stage, and the third sub-frequency-falling beat frequency f_{b23} of the third frequency-falling stage are both negative values, which are collectively referred to as the frequency-falling beat frequency f_{b2} in this embodiment. The effective length of the frequency-falling beat frequency f_{b2} of FIG. 3 (c) is less than the effective length of the frequency-falling beat frequency f_{b2} of FIG. 3 (a).

With reference to FIG. 2 (c) and FIG. 3 (c), the distance R of the obstacle measured by the FMCW LiDAR system in this embodiment satisfies the following relationship:

$$R = \frac{{C}_{0}}{4} \frac{{t}_{c}}{{f}_{c}} ( \vert {f}_{b 1} \vert + \vert {f}_{b 2} \vert )$$

where tc is one half of the preset frequency-sweeping ranging period, fc is the preset frequency-sweeping total bandwidth, f_{b1} is the frequency-rising beat frequency in the frequency-rising stage, and f_{b2} is the frequency-falling beat frequency in the frequency-falling stage.

Correspondingly, the speed v of the obstacle measured by the FMCW LiDAR system in this embodiment satisfies the following relationship:

$$v = - \frac{{C}_{0}}{4} \frac{1}{{f}_{s}} ( \vert {f}_{b 1} \vert - \vert {f}_{b 2} \vert )$$

where tc is one half of the preset frequency-sweeping ranging period, c₀ is the speed of light, f_{b1} is the frequency-rising beat frequency of the frequency-rising stage, f_{b2} is the frequency-falling beat frequency in the frequency-falling stage, and fs is the frequency of the unmodulated light beam.

That is, the distance measurement formula and the speed measurement formula of the FMCW LiDAR system using the small frequency-sweeping bandwidth range is the same as the distance measurement formula and the speed measurement formula of the FMCW LiDAR system using the large frequency-sweeping bandwidth range, so that a similar measurement effect can be obtained.

In the foregoing embodiment, for example, n=3 is used for description, the frequency-sweeping bandwidth f is ⅓ of the preset frequency-sweeping total bandwidth fc, and the frequency-rising stage and the frequency-falling stage in the preset frequency-sweeping ranging period using the large frequency-sweeping bandwidth range are just divided into three frequency-rising stages and three frequency-falling stages, respectively.

In other embodiments, n may also be another value, for example, n is a positive number, and n≥2. n may be an integer or a decimal. When n is an integer, the frequency-rising stage and the frequency-falling stage in the preset frequency-sweeping ranging period using the large frequency-sweeping bandwidth range are divided into n frequency-rising stages and n frequency-falling stages, respectively. That is, when a small frequency-sweeping bandwidth range is used, n complete periodic frequency-rising and n complete periodic frequency-falling are included in the preset frequency-sweeping ranging period. Each complete periodic frequency-rising adopts a preset frequency-rising slope, and each complete periodic frequency-falling adopts a preset frequency-falling slope. In the present disclosure, the preset frequency-rising slope is a frequency-rising slope of a frequency-rising stage in a preset frequency-sweeping ranging period using a large frequency-sweeping bandwidth range, and the preset frequency-falling slope is a frequency-falling slope of a frequency-falling stage in a preset frequency-sweeping ranging period using a large frequency-sweeping bandwidth range. The time occupied by the complete periodic frequency-rising or the complete periodic frequency-falling is t=f*tc/2fc=tc/2n.

For example, as shown in FIG. 2 (a), when a large frequency-sweeping bandwidth range is used, the preset frequency-sweeping total bandwidth fc is 3 GHz, the preset frequency-sweeping ranging period is 40 μs, and in a preset frequency-sweeping ranging period, the frequency-rising stage and the frequency-falling stage both occupy 20 μs. When using a small frequency-sweeping bandwidth range, for example, as shown in FIG. 2(b) and FIG. 2(c), the frequency-sweeping bandwidth f=fc/3=1 GHz, and one preset frequency-sweeping ranging period includes three complete periodic frequency-rising sub-stage and three complete periodic frequency-falling sub-stage, each complete periodic frequency-rising sub-stage occupies (20/3) μs and each complete periodic frequency-falling sub-stage occupies (20/3) μs.

When n is a decimal, a frequency-rising stage in a preset frequency-sweeping ranging period using a large frequency-sweeping bandwidth range may be divided into └n┘ frequency-rising sub-stages, i.e. └n┘ complete frequency-rising sub-stages and one incomplete frequency-rising sub-stage; correspondingly, a frequency-falling stage in the preset frequency-sweeping ranging period using the large frequency-sweeping bandwidth range may be divided into: └n┘ frequency-falling sub-stages, i.e. └n┘ complete frequency-falling sub-stages and one incomplete frequency-falling sub-stage; wherein └n┘ indicates a round down calculation. That is, when a small frequency-sweeping bandwidth range is used, the preset frequency-sweeping ranging period includes └n┘ complete frequency-rising sub-stages and └n┘ complete frequency-falling sub-stages, and at least one incomplete frequency-rising sub-stage, and at least one incomplete frequency-falling sub-stage. The at least one incomplete frequency-rising sub-stage and the at least one incomplete frequency-falling sub-stage may be used as redundancy stages.

For example, as shown in FIG. 2(a), when a large frequency-sweeping bandwidth range is used, the preset frequency-sweeping total bandwidth fc is 3 GHz, the preset frequency-sweeping ranging period is 40 s, and in a preset frequency-sweeping ranging period, the frequency-sweeping bandwidth f=fc/2.5=1.2 GHz. A preset frequency-sweeping ranging period includes two complete periodic frequency-rising sub-stage, two complete periodic frequency-falling sub-stage, one incomplete frequency-rising sub-stage, and one incomplete frequency-falling sub-stage. Each complete periodic frequency-rising sub-stage occupies 8 μs, and each complete periodic frequency-falling sub-stage occupies 8 μs; one incomplete frequency-rising sub-stage occupies 4 μs, and one incomplete frequency-falling sub-stage occupies 4 μs.

As described above, the frequency-sweeping light beam generated by the FMCW LiDAR system provided in the foregoing embodiment performs n times of complete periodic frequency-rising based on the preset frequency-rising slope in the preset frequency-sweeping ranging period and performs n times of complete periodic frequency-falling based on the preset frequency-falling slope in the preset frequency-sweeping ranging period. The frequency-sweeping bandwidth of the frequency-sweeping light beam is obviously smaller than the preset frequency-sweeping total bandwidth, and the large-range frequency-sweeping is replaced by the small-range frequency-sweeping during FMCW ranging and measurement. The frequency-sweeping slope is consistent with fc/tc, while achieving the same measurement effect, the bandwidth requirement of the frequency-sweeping is reduced, so that the FMCW LiDAR system is simple, the power consumption of the system is low, and the cost is reduced.

In some embodiments, there is a certain limitation on the value of n, where n satisfies the following relationship:

$$n < \frac{{t}_{c}}{{t}_{max}}$$

$$and$$

$${t}_{max} = \frac{2 {R}_{max}}{{C}_{0}}$$

where Tc is one half of the preset frequency-sweeping ranging period, Rmax is the preset maximum ranging distance, and C₀ is the speed of light. Rmax is the preset maximum ranging distance determined by design parameters of the FMCW LiDAR system.

In some embodiments, the FMCW LiDAR system 100 further includes a beam-scanning guide device 160 configured to adjust an emission direction of an emitted beam transmitted from the light transmitter over time to implement beam scanning. The beam-scanning guide device is, for example, an optical phased array (OPA), which can guide the direction of the light beam by dynamically controlling the optical characteristics of the surface on the microscopic scale. In other embodiments, the beam-scanning guide device may further include one or more of a grating, a mirror galvanometer, a polygon mirror, a MEMS mirror, or f an optical phased array (OPA) and the foregoing apparatus.

In the solution of using a small frequency-sweeping bandwidth range in the present disclosure, as shown in FIG. 2 (b), 2 (c), 3 (b) and 3 (c), the frequency-rising beat frequency f_{b1} satisfies the following relationship:

$${f}_{b 1} = ( {f}_{b 11} + {f}_{b 12} + … + {f}_{b 1 n} ) / n$$

where f_{b11} is the first sub-frequency-rising beat frequency, and is determined in the first frequency-rising sub-stage; f_{b12} is the second sub-frequency-rising beat frequency, and is determined in the second frequency-rising sub-stage; f_{b1n} is the n-th sub-frequency-rising beat frequency, and is determined in the n-th frequency-rising sub-stage.

The frequency-falling beat frequency f_{b1} satisfies the following relationship:

$${f}_{b 2} = ( {f}_{b 21} + {f}_{b 22} + … + {f}_{b 2 n} ) / n$$

where f_{b21} is the first sub-frequency-falling beat frequency, and is determined in the first frequency-falling sub-stage; f_{b22} is the second sub-frequency-falling beat frequency, and is determined in the second frequency-falling sub-stage; f_{b2n} is the n-th sub-frequency-falling beat frequency, and is determined in the n-th frequency-falling sub-stage.

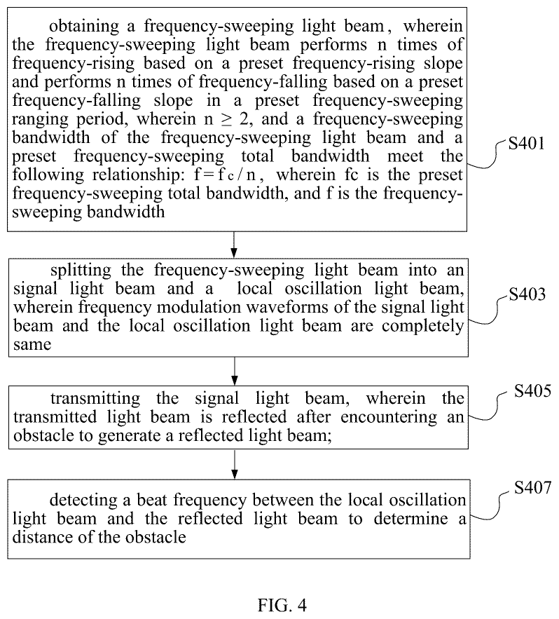

FIG. 4 is a flowchart of an FMCW frequency-sweeping method according to some implementations of the present disclosure. As shown in FIG. 4, some embodiments of the present disclosure further provide an FMCW frequency-sweeping method, which is applied to a LiDAR system, and may adopt the FMCW LiDAR system 100 described in the foregoing embodiment, and the FMCW frequency-sweeping method includes the following steps S401 to S407.

S401: obtaining a frequency-sweeping light beam.

A laser beam is generated by the laser light source 110, and the laser light source 110 may be directly modulated by a chirp signal, for example, a drive signal for controlling the laser light source 110, which may be input to the laser light source 110 at a time varying intensity, so that the laser light source 110 generates and outputs a frequency-sweeping beam, that is, a beam whose frequency varies within a predetermined range. In some embodiments, the laser light source 202 may further include a modulator that receives the modulation signal. The modulator may be configured to modulate the laser beam based on the modulation signal to generate and output the frequency-sweeping beam, i.e. a beam of frequency that varies in a predetermined range.

In the FMCW frequency-sweeping method, the frequency-sweeping light beam performs n times of complete periodic frequency-rising and n complete periodic frequency-falling based on preset frequency-rising slopes within a preset frequency-sweeping ranging period, n is a positive number and n≥2, and the frequency-sweeping bandwidth of the frequency-sweeping light beam and the preset frequency-sweeping total bandwidth meet the following relationship:

$$f = {f}_{c} / n$$

where fc is the preset frequency-sweeping total bandwidth, and f is the frequency-sweeping bandwidth.

In some embodiments, the frequency-sweeping light beam sequentially and continuously implements └n┘ times of complete periodic frequency-rising and └n┘ times of complete periodic frequency-falling in a preset frequency-sweeping ranging period, └n┘ indicates that n is rounded down, see FIG. 2 (b) and FIG. 3 (b).

In some embodiments, the frequency-sweeping light beam continuously and alternately performs └n┘ times of complete periodic frequency-rising and └n┘ times of complete periodic frequency-falling in a preset frequency-sweeping ranging period, └n┘ indicates that n is rounded down, see FIG. 2 (c and FIG. 3 (c).

S403: splitting the frequency-sweeping light beam into a signal light beam and a local oscillation light beam, wherein the frequency modulation waveforms of the signal light beam and the local oscillation light beam are completely the same.

The beam splitter 120 is used to split the received frequency-sweeping light beam into the signal light beam and the local oscillation light beam, and the signal light beam and the local oscillation light beam have the same frequency at any time point, that is, the frequency modulation waveforms of the signal light beam and the local oscillation light beam are completely the same.

S405: transmitting the signal light beam so that the transmitted light beam is reflected to generate a reflected light beam after encountering an obstacle.

The optical transmitter 130 is used to transmit the signal light beam at a predetermined angle, and the optical receiver 140 is used to receive the reflected light beam reflected by the obstacle after encountering the obstacle.

S 407: detecting a beat frequency between the local oscillation light beam and the reflected light beam to determine a distance of the obstacle.

The detector detects the beat frequency between the local oscillation light beam and the reflected light beam, and then the processor calculates the distance between the obstacle and the FMCW LiDAR system 100, and when the obstacle is a moving object, the processor may further calculate the speed of the obstacle according to the beat frequency detected by the detector 150.

The frequency-sweeping light beam in the frequency-sweeping method provided by the present disclosure performs n times of frequency-rising based on a preset frequency-rising slope and performs n times of frequency-falling based on a preset frequency-falling frequency in a preset frequency-sweeping ranging period, the frequency-sweeping bandwidth of the frequency-sweeping light beam is obviously smaller than the preset frequency-sweeping total bandwidth, large-range frequency-sweeping is replaced by small-range frequency-sweeping of the FMCW distance ranging method of the present disclosure, the same measurement effect is achieved, meanwhile, requirement of the frequency-sweeping bandwidth is reduced, the FMCW LiDAR system is simple, the system power consumption is low, and the cost is reduced.

In this specification, each part is described in a manner of combining parallel and progressive, each part focuses on a difference from other parts, and the same or similar parts among the parts refer to each other.

With regard to the above description of the disclosed embodiments, the features described in the embodiments of the present disclosure may be replaced or combined with each other, so that those skilled in the art can implement or use the present disclosure. Various modifications to these embodiments will be apparent to those skilled in the art, and the general principles defined herein may be implemented in other embodiments without departing from the spirit or scope of the present disclosure. Thus, the present disclosure will not be limited to the embodiments shown herein but is to be accorded the widest scope consistent with the principles and novel features disclosed herein.

Finally, it should be noted that the embodiments in this specification are described by way of example, each embodiment focuses on differences from other embodiments, and the same or similar parts between the embodiments refer to each other. For the system or device disclosed in the embodiment, since it corresponds to the method disclosed in the embodiments, the description is relatively simple, and for the relevant parts, reference may be made to the description of the method part.

Although the present disclosure has been described in detail with reference to the foregoing embodiments, a person of ordinary skill in the art should understand that the technical solutions described in the foregoing embodiments may still be modified, or some of the technical features may still be equivalently replaced; and these modifications or replacements do not make the essence of the corresponding technical solutions depart from the spirit and scope of the technical solutions of the embodiments of the present disclosure.

1. A Frequency-Modulated Continuous Wave (FMCW) frequency-sweeping method applied to a Llght Detection And Ranging (LiDAR) system, comprising:
obtaining a frequency-sweeping light beam;
splitting the frequency-sweeping light beam into an signal light beam and a local oscillation light beam, wherein frequency modulation waveforms of the signal light beam and the local oscillation light beam are completely same;
transmitting the signal light beam, wherein the transmitted light beam is reflected after encountering an obstacle to generate a reflected light beam; and
detecting a beat frequency between the local oscillation light beam and the reflected light beam to determine a distance of the obstacle,
wherein the frequency-sweeping light beam performs n times of frequency-rising based on a preset frequency-rising slope and performs n times of frequency-falling based on a preset frequency-falling slope in a preset frequency-sweeping ranging period, wherein n≥2, and a frequency-sweeping bandwidth of the frequency-sweeping light beam and a preset frequency-sweeping total bandwidth meet the following relationship:
$$f = {f}_{c} / n$$
wherein fc is the preset frequency-sweeping total bandwidth, and f is the frequency-sweeping bandwidth.

2. The FMCW frequency-sweeping method according to claim 1, wherein the frequency-sweeping light beam sequentially and continuously performs └n┘ times of complete periodic frequency-rising and └n┘ times of complete periodic frequency-falling in the preset frequency-sweeping ranging period, └n┘ indicates that n is rounded down.

3. The FMCW frequency-sweeping method according to claim 1, wherein the frequency-sweeping light beam continuously and alternately executes └n┘ times of complete periodic frequency-rising and └n┘ times of complete periodic frequency-falling in the preset frequency-sweeping ranging period, └n┘ indicates that n is rounded down.

4. The FMCW frequency-sweeping method according to claim 1, wherein a distance R of the obstacle measured by the FMCW LiDAR system satisfies the following relationship:
$$R = \frac{{C}_{0}}{4} \frac{{t}_{c}}{{f}_{c}} ( \vert {f}_{b 1} \vert + \vert {f}_{b 2} \vert )$$
wherein tc is one half of the preset frequency-sweeping ranging period, fc is the preset frequency-sweeping total bandwidth, f_{b1} is a frequency-rising beat frequency in a frequency-rising stage, and f_{b2} is a frequency-falling beat frequency in a frequency-falling stage.

5. The FMCW frequency-sweeping method according to claim 1, wherein a speed v of the obstacle measured by the FMCW LiDAR system satisfies the following relationship:
$$v = - \frac{{C}_{0}}{4} \frac{1}{{f}_{o}} ( \vert {f}_{b 1} \vert - \vert {f}_{b 2} \vert )$$
wherein tc is one half of the preset frequency-sweeping ranging period, C₀ is the speed of light, f_{b1} is a frequency-rising beat frequency of a frequency-rising stage, f_{b2} is a frequency-falling beat frequency in a frequency-falling stage, and fo is a frequency of an unmodulated light beam.

6. The FMCW frequency-sweeping method according to claim 1, wherein n satisfies the following relationship:
$$n < \frac{{t}_{c}}{{t}_{max}} and {t}_{max} = \frac{2 {R}_{max}}{{C}_{0}}$$
wherein tc is one half of the preset frequency-sweeping ranging period, Rmax is a preset maximum ranging distance, and C₀ is the speed of light.

7. A Frequency-Modulated Continuous Wave (FMCW) Llght Detection And Ranging (LiDAR) system, comprising:
a laser light source configured to generate a frequency-sweeping light beam;
an optical splitter configured to split the frequency-sweeping light beam into a signal light beam and a local oscillation light beam, wherein frequency modulation waveforms of the signal light beam and the local oscillation light beam are completely the same;
an optical transmitter configured to transmit the signal light beam, wherein the transmitted light beam is reflected to generate a reflected light beam after encountering an obstacle;
an optical receiver configured to receive the reflected light beam;
a detector configured to detect a beat frequency between the local oscillation light beam and the reflected light beam to determine a distance of the obstacle,
wherein the frequency-sweeping light beam performs n times of frequency-rising based on a preset frequency-rising slope and performs n times of frequency-falling based on a preset frequency-falling slope in a preset frequency-sweeping ranging period, wherein n≥2, and a frequency-sweeping bandwidth of the frequency-sweeping light beam and a preset frequency-sweeping total bandwidth meet the following relationship:
$$f = {f}_{c} / n$$
wherein fc is the preset frequency-sweeping total bandwidth, and f is the frequency-sweeping bandwidth.

8. The FMCW LiDAR system according to claim 7, wherein the frequency-sweeping light beam sequentially and continuously performs └n┘ times of complete periodic frequency-rising and └n┘ times of complete periodic frequency-falling in the preset frequency-sweeping ranging period, └n┘ indicates that n is rounded down.

9. The FMCW LiDAR system according to claim 7, wherein the frequency-sweeping light beam continuously and alternately executes └n┘ times of complete periodic frequency-rising and └n┘ times of complete periodic frequency-falling in the preset frequency-sweeping ranging period, └n┘ indicates that n is rounded down.

10. The FMCW LiDAR system according to claim 7, wherein the FMCW LiDAR system further comprises:
a beam-scanning guide device, configured to adjust an emission direction of the transmitted light beam emitted from the optical transmitter over time to realize beam scanning.
